(19) United States
(12) Patent Application Publication
(10) Pub. No.: US 2026/0119835 A1
(43) Pub. Date: Apr. 30, 2026

(54) TALK-TO-LARGE LANGUAGE MODELS SYSTEMS AND METHODS

(71) Applicant: BlackRock Finance, Inc., New York, NY (US)

(72) Inventors: Stefano Pasquali, New York, NY (US); Harrison Garber, Atlanta, GA (US); Deran Onay, New York, NY (US); Dhagash Mehta, Chester Springs, PA (US); Tianjiao Zhao, Norcross, GA (US); Dimitrios Vamvourellis, New York, NY (US); Rohit K. Sharma, Springfield, NJ (US); Mengchen Zhu, New York, NY (US); Aditya Dave, New York, NY (US); Bhaskarjit Sarmah, New Delhi (IN); Nagore Sabio Arteaga, Hoboken, NJ (US); Lucas Ou, New York, NY (US); Avi Shah, Jersey City, NJ (US)

(21) Appl. No.: 19/267,119

(22) Filed: Jul. 11, 2025

(30) Foreign Application Priority Data
Oct. 28, 2024 (IN) 202441082248

(51) Int. Cl. G06N 3/042; G06N 3/0475; G06N 3/096

(52) U.S. Cl. CPC G06N 3/042; G06N 3/0475; G06N 3/096

(57) ABSTRACT

The embodiments are directed to a system, method, and computer program product for processing analytical queries. A system receives an analytical query from a user interface. The system parses and classifies the analytical query. The system traverses a domain hierarchy tree based on the parsed and classified query to identify one or more leaf nodes corresponding to data sources, wherein the domain hierarchy tree comprises nodes storing descriptions and few-shot examples. The system generates a plan to execute the query based on information in the identified leaf nodes. The system extracts data from one or more data sources based on the generated plan. The system generates a prompt for a neural network model based on the extracted data and the analytical query and executes the prompt using the neural network model to generate a result. The system generates an answer to the analytical query based on the result.

### CROSS-REFERENCE TO RELATED APPLICATIONS

This application claims priority to Indian Provisional Application No. 202441082248, filed on Oct. 28, 2024, which is hereby incorporated by reference in its entirety.

### FIELD OF INVENTION

The embodiments are directed to artificial intelligence agents that use large language models, and more specifically to supplementing queries to large language models with data to lead to more accurate results.

### BACKGROUND

Large language models (LLMs) can be valuable tools for creating an intuitive and singular interface that can orchestrate communication over large amounts of data. Having such a layer simplifies displaying information and insights that are otherwise difficult to locate and/or understand. LLMs can be particularly beneficial for accurately processing domain expertise and model-specific knowledge. However, using LLMs to access, analyze, and process numerical data may be counterproductive because LLMs are typically untrained and unreliable at mathematical reasoning. This is because LLMs were designed to analyze linguistic tasks, and not mathematical tasks. Moreover, LLMs may lack the deep domain expertise and proprietary analytics to be able to answer queries correctly. Finally, LLMs may hallucinate even in simple non-numeric scenarios.

### BRIEF DESCRIPTION OF FIGURES

FIG. 1 is a diagram of a computing environment where embodiments may be implemented.

FIG. 2 is a computing architecture that includes an AI processing system, according to some embodiments.

FIG. 3 is a diagram of a domain hierarchy tree, according to some embodiments.

FIG. 4 is a flowchart of a method for generating content using a domain hierarchy tree and an AI processing system, according to some embodiments.

FIG. 5 is a simplified diagram illustrating the neural network structure that may be implemented by one or more components in neural network model, according to some embodiments.

FIG. 6 is a block diagram of a computer system suitable for implementing one or more components or operations in FIGS. 1-5, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The embodiments are directed to an AI processing system designed to address challenges associated with using large language models for numerical reasoning in various contexts. This AI processing system provides a novel approach to handling analytical queries by translating user requests that include the analytical queries into executable code that operates on numerical datasets rather than the large language models directly operating on the numerical datasets.

The AI processing system may be accessed via an AI plug-in that differentiates between analytical and non-analytical requests. Analytical requests may require mathematical computations while non-analytical requests typically do not. Non-analytical requests may be passed for processing by various applications that may or may not invoke large language models, while analytical requests may be directed to the AI processing system which generates code that may access and obtain and manipulate data using one or more data sources, such as a data storage or an application accessible via an API call. A large language model may then be invoked with a prompt that includes the data. To identify data sources, the AI processing system may access a domain hierarchy tree. The domain hierarchy tree may store information associated with various domains and data sources, such as databases, APIs, file systems, etc., as nodes in the domain hierarchy tree. Each node may also include a description of the domain or data source, domain or data source specific knowledge, and a few-shot examples identifying example data that may be included in the data source, and/or format and parameters of the API calls. The domain hierarchy tree may be traversed based on the content in the user request until the nodes with the data sources are identified. The AI processing system may then obtain data from the identified data sources by generating data queries or API calls.

By utilizing this approach, the AI processing system may overcome limitations of traditional large language models when dealing with numerical data. For example, instead of using a large language model to perform computations, where it is known to be inaccurate and potentially hallucinate, the AI processing system may be able to perform complex computations and analytics by generating computing code that accesses a data source to retrieve data and performing the computations using the computing code. The results generated by the computing code may then be formatted into a prompt and transmitted to the machine learning framework that includes a large language model for further analysis. The AI processing system may be applied to analyzing data in various applications, including finance, scientific research, engineering, or data analytics.

The AI processing system offers several technical improvements over traditional approaches to handling analytical queries and numerical reasoning. One key improvement is the algorithmic approach to numerical reasoning. Instead of relying on large language models to directly perform mathematical operations, which can lead to inaccuracies and hallucinations, the AI processing system translates user requests into executable code. This code may then access and manipulate data from various sources using data and API calls, performing complex computations and analytics with high accuracy and reliability. The manipulated data is then transmitted to the machine learning framework that includes large language models for further processing.

Another significant improvement is the incorporation of encoded subject matter expert (SME) knowledge within the domain hierarchy tree. Each dataset and API node in the tree may include not only descriptions of the data source or domain, but also domain-specific knowledge and nuances that are crucial for accurate data interpretation and usage. This encoded SME knowledge may aid the AI processing system to understand the context and limitations of each data source, leading to more informed and accurate request processing.

The AI processing system also employs a hierarchical knowledge search mechanism to efficiently subset relevant information before processing. By representing domain coverage as a tree structure and performing shallow searches across domain definitions, the system may quickly identify the most relevant data sources for a given request. This approach may significantly reduce the context size processed and/or searched by the AI processing system, addressing potential attention issues and context limits of large language models. Additionally, the AI processing system utilizes a uniform information representation, where all data sources, regardless of their original format or storage method, are represented as nodes in the domain hierarchy tree. This uniformity may simplify the process of retrieving and combining information from diverse sources, enhancing the AI processing system's ability to generate comprehensive and accurate responses to complex analytical queries.

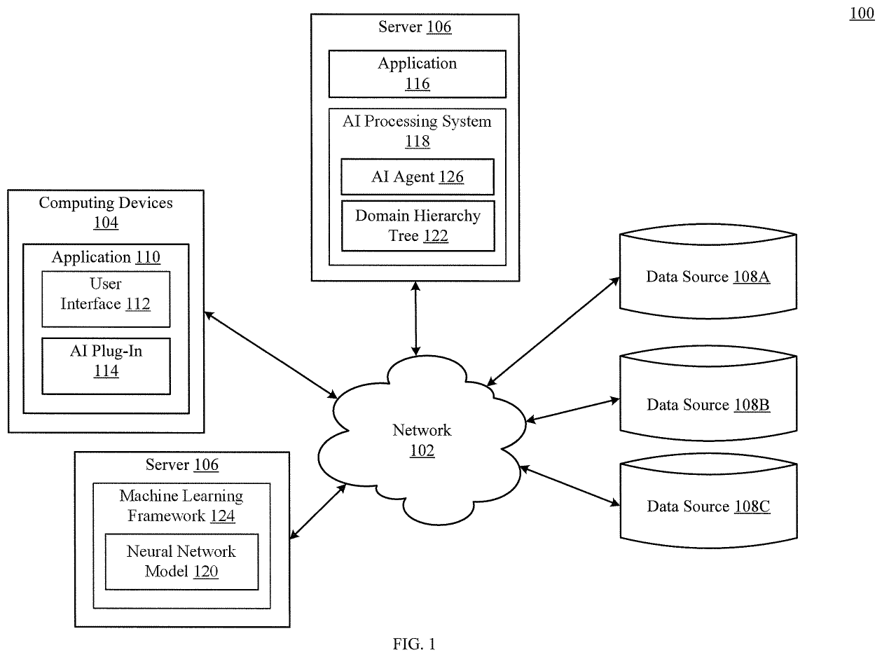

FIG. 1 is a block diagram of a computing environment 100 where embodiments may be implemented. The computing environment 100 in FIG. 1 may have various computing devices and applications that are communicatively connected over a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network. Network 102 may be accessible by various components of computing environment 100.

Computing environment 100 also includes one or more computing devices 104, servers 106, and data sources 108 coupled to the network 102. Computing devices 104 may include portable and non-portable electronic devices under control of a user and configured to transmit, receive, and manipulate data, execute various applications, and communicate with other devices connected to the network 102. Example computing devices 104 include desktop computers, laptop computers, tablets, smartphones, wearable computing devices, eyeglasses, three-dimensional glasses, and/or headsets that incorporate computing devices and/or include visual oculography application interface (VOG API), implantable computing devices, etc.

Computing device(s) 104 may include an application 110. Application 110 may include a user interface 112 and an artificial intelligence (AI) plug-in 114. Application 110 may execute on computing device(s) 104 and display data and/or content to a user via user interface 112. User interface 112 may be used for interaction between a user and computing device 104. For example, computing device 104 may receive input, e.g., commands, prompts, or instructions via user interface 112. The input may cause computing device 104 to request data, content, etc., from a counterpart to application executing on a server, such as an application 116. In some instances, commands and/or prompts may be received using an input device, such as a keyboard, mouse, a screen with a touch interface, a stylus, a microphone, a camera, a VOG interface, and the like. Application 110 may also display data, including trading data, quote data, climate data, risk data, security data, visual data representations, including data in charts and/or graphs, and the like. Additionally, application 110 may display data analytics, include various dashboards, and the like.

In some instances, application 110 may be a browser. A browser may access and display content of application 116 by accessing a website corresponding to application 116 on server 106. The website may be accessible by entering a uniform resource locator (URL) into the browser via user interface 112. The browser may translate a domain name included in the URL into an Internet Protocol (IP) address corresponding to server 106 where the website of application 116 is hosted and send an HTTP (Hypertext Transfer Protocol) request message to the server 106 where the website is hosted. Server 106 may respond with an HTTP response message that includes a webpage from the website and content of the website. The content may be included in Hypertext Markup Language (HTML) files, Cascading Style Sheets (CSS), JavaScript, images, and the like.

Server 106 in computing environment 100 may be a processor or multiple centralized or cloud processors within a device conducive to processing and storing large amounts of data that may be inefficient or impractical to process and store on computing devices 104. There may be multiple servers 106 that communicate with each other over network 102.

Application 110 may include an AI plug-in 114. In a browser embodiment, the browser may include a button that may access the functionality of AI plug-in 114. AI plug-in 114 may receive a request or query for information associated with the data and pass the request to application 116 or AI processing system 118 executing on server(s) 106. In some instances, AI plug-in 114 may determine that the request is for analytical or non-analytical information. A request for analytical information may be routed to AI processing system 118, while a request for non-analytical information may be routed to application 116.

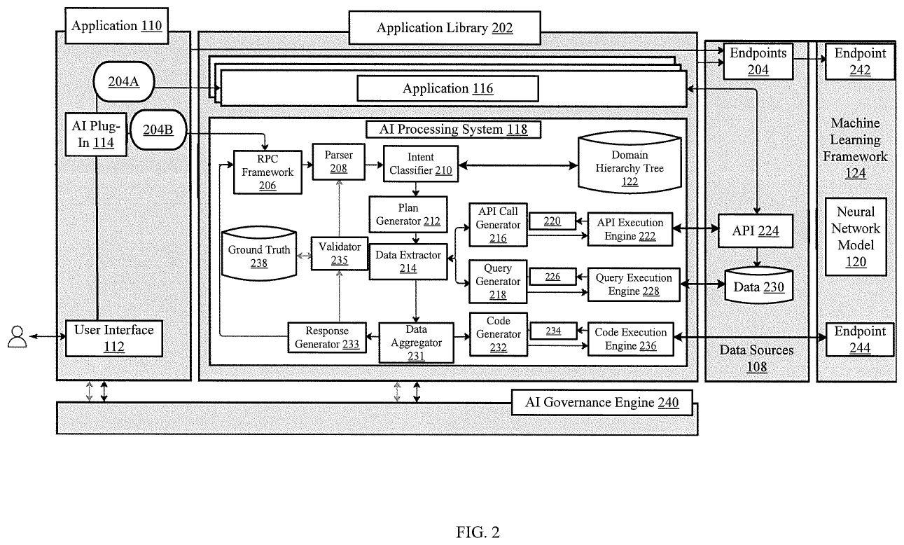

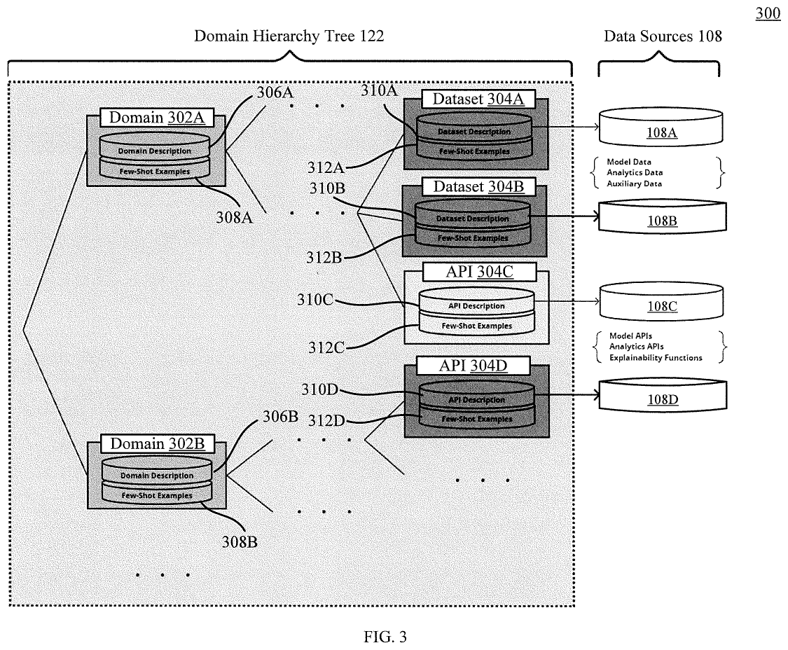

Server 106 may store and/or execute AI processing system 118. AI processing system 118 may include various modules and a domain hierarchy tree 122 for processing requests with analytical information. The AI processing system 118 is discussed in further detail in FIG. 2 and the domain hierarchy tree 122 is discussed in further detail in FIG. 3 and below.

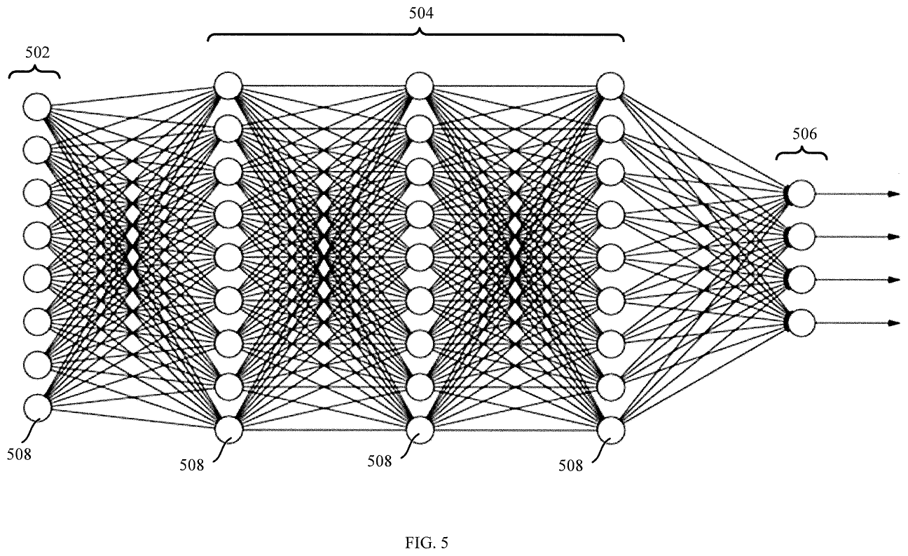

The same or different server 106 may also include a machine learning framework 124. The machine learning framework 124 may include various components for training, evaluating, and deploying machine learning models, such as neural networks, decision trees, and support vector machines. In some instances, machine learning framework 124 may include a neural network model 120. Neural network model 120 may be a large language model in some embodiments conducive to receiving a prompt and generating an answer in a natural language. Further structure and function of neural network model 120 is discussed in more detail in FIG. 5.

Domain hierarchy tree 122 is a searchable tree structure representing domain coverage that may be associated with multiple data resources 108. Domain coverage may include domain definitions, encoded subject matter knowledge, such as specific fields, data sets, etc., that may be relevant to determining an answer to a prompt processed by AI processing system 118. Each node in the domain hierarchy tree 122 may include a domain, data or API description, define logical groupings of data, define search hierarchy, define validation scenarios as ground truth examples, and/or few-shot examples. Further, the leaf nodes of the domain hierarchy tree 122 may include information corresponding to data sources 108 that may store data relevant to answering the prompt and/or a dataset and/or application program interface (API) that may be used to access or manipulate the data in data sources 108.

For example, AI plug-in 114 routes a request to AI processing system 118. The prompt in the request may ask if there are liquid underpriced bonds similar to a particular security or another type of a request for analytical information that requires mathematical computations to generate an answer. The top level of the domain hierarchy tree 122 may include various domains, such as a trading domain, a climate domain, and the like. Using domain descriptions in domain hierarchy tree 122, AI processing system 118 may categorize the prompt as a trading prompt. AI processing system 118 may then traverse the trading domain branch of domain hierarchy tree 122 and search the nodes in the trading domain branch to determine whether the prompt relates to bond, equity, or mortgage analytics. The search at each node may include a comparison between the prompt, the domain description, and the few-shot examples at that node. The search may continue until the leaf node in domain hierarchy tree 122 is reached, from which data in the corresponding data source 108, such as data source 108A, 108B, or 108C may be accessed to generate a response to the prompt.

Data sources 108A-C may store data that may be accessed and/or analyzed by application 116 and AI processing system 118. Data sources 108A-C may be file systems, databases, cloud storage, physical storage devices, network attached data sources, and the like. Data sources 108A-C may have different application programming interfaces (APIs) that may be used to access data in data sources 108A-C. For example, SQL, Oracle, graph databases may all have different APIs, such as a structured query language (SQL) for a SQL database, procedural language (PL)/SQL for an Oracle database, and a Cypher or Gremlin for a graph database. Similarly, other APIs may be in Java, Python, C, C++, and/or proprietary API languages to access various data sources 108A-C. The leaf nodes in domain hierarchy tree 122 may store the various APIs that correspond to data sources 108A-C that may store data for answering the prompt from user interface 112.

When application 116 receives a request, application 116 may determine that the request is not a request for analytical information and may process the request. Alternatively, if the request is for analytical information, application 116 may pass the request to AI processing system 118. Alternatively, as discussed above, AI plug-in 114 may route the request that is not for analytical information to application 116 and request for analytical information to AI processing system 118.

AI processing system 118 may traverse the prompt in the request using domain hierarchy tree 122, until one of the leaf nodes is reached. The traversal may be based on a search that compares content in the prompt to the content in the descriptions and few-shot examples in domain hierarchy tree 122. Once one or more leaf nodes are reached, AI processing system 118 may generate code for retrieving or manipulating the data or accessing the API described in the leaf node. The AI processing system 118 may then generate a prompt with the data or API results to neural network model 120. The prompt to the neural network mode 120 may include the prompt from the user interface 112, the data retrieved from the data source, API, etc., at the leaf node(s), and the few-shot examples at the leaf node(s). Based on the prompt, neural network model 120 may generate a response. The response may include an answer to the request generated by user interface 112 or an intermediate answer that may be used for further processing by AI processing system 118. In some instances, AI processing system 118 may perform the above multiple times until the answer is generated for display on user interface 112.

FIG. 2 is a diagram 200 of a computing architecture that includes the AI processing system, data sources, and a machine learning framework, according to some embodiments. As illustrated in FIG. 2, user interface 112 receives a request (e.g., a query) from a user, which is then passed to AI plug-in 114. The request may be received through various input methods. In some cases, the user interface 112 may include a text input field where users can type their queries or commands directly. The interface may also provide buttons, dropdown menus, or other interactive elements that users can click or select to initiate specific requests or actions. Voice input may be supported in some implementations, allowing users to speak their requests or commands, which are then processed and converted to text by speech recognition and speech-to-text technologies. For devices with touch capabilities, the user interface 112 may accept touch gestures such as taps, swipes, or multi-finger inputs to interact with the application and submit requests.

AI plug-in 114 may receive a request from user interface 112. In some instances, AI plug-in 114 may parse the request and route the request to AI processing system 118. In other instances, AI plug-in 114 may route the request to application 116, which may then route the request to AI processing system 118. The request may include a question or a prompt, the answer to which may be generated using application 116 and/or AI processing system 118. In some cases, AI plug-in 114 may analyze the content and structure of each request to determine whether it is analytical or non-analytical in nature. In some cases, AI plug-in 114 may cause application 110 to access machine learning framework 124 through endpoints 204, 242, and use neural network model 120 and natural language processing techniques to parse the request and identify key terms, phrases, or patterns that indicate a request that may be answered using mathematical computations or data analysis. For example, requests containing words like “calculate”, “compare”, “trend”, or “forecast” may be flagged as potentially analytical.

For requests determined to be non-analytical, AI plug-in 114 may package the request as a non-analytical prompt 204A and route the request to application 116 for processing. This may include requests for information retrieval, navigation actions, or other operations that do not involve complex data analysis. Requests identified as analytical may be formatted as analytical prompt 204B and routed to AI processing system 118.

Server 106 may include an application library 202 that houses various software components and modules that may execute on server 106. In some aspects, application library 202 may contain application 116 and AI processing system 118, along with other applications that may be utilized for different purposes. Application library 202 may allow for efficient organization and management of multiple software resources on server 106. In some cases, the applications within application library 202 may interact with each other, sharing data or functionalities as needed. The presence of application library 202 on server 106 may facilitate easier updates, maintenance, and integration of new features across the various applications, including application 116 and AI processing system 118.

Application 116 may process non-analytical prompt 204A by first analyzing the content and context of the request. In some cases, application 116 may utilize natural language processing techniques and machine learning framework 124 to extract key information and/or generate an output from the non-analytical prompt. For example, content in non-analytical prompt 204A may be transmitted over endpoints 204, 242, to machine learning framework 124. The response from machine learning framework 124 may then be incorporated into the final output that application 116 prepares for the user and that is transmitted to user interface 112.

Upon receiving analytical prompt 204B, AI processing system 118 may parse and rephrase prompt 204B. AI processing system 118 may then route prompt 204B to domain hierarchy tree 122. As discussed above, domain hierarchy tree 122 is a searchable tree that includes domains and few-shot examples at each of its nodes. The rephrased query is propagated through domain hierarchy tree 122 by being compared against the few-shot examples at each node in domain hierarchy tree 122 until the rephrased prompt 204B reaches one or more leaf nodes. From the database and/or API information stored in the leaf nodes, the few-shot examples in the leaf nodes, and the rephrased prompt 204B, AI processing system 118 may generate a prompt to a neural network model 120. The prompt is processed by neural network model 120 to generate a query to one or more data sources, APIs, etc., to retrieve data. AI processing system 118 may execute the query generated by neural network model 120 to retrieve data from the relevant data source, which serves as an answer to the query received via user interface 112. The retrieved data may be formatted using neural network model 120 and/or passed to user interface 112 as the answer to the query.

More specifically, the AI processing system 118 may process analytical prompt 204B. The analytical prompt 204B may be received by a remote procedure call (RPC) framework 206. The RPC framework 206 may serve as a communication layer between application 110 executing on computing device 104 and AI processing system 118 executing on server 106. RPC framework 206 may facilitate remote procedure calls and data exchange. In some implementations, RPC framework 206 may handle serialization and deserialization of data, manage network connections, and provide error handling mechanisms to ensure reliable communication between application 110 and AI processing system 118.

RPC framework 206 may pass the analytical prompt 204B to parser 208. Parser 208 may analyze and decompose the analytical prompt 204B into its constituent elements, identifying key components such as the main query, any specified parameters, and contextual information. The parser may also standardize the input by removing any extraneous information, correcting spelling errors, and normalizing terminology to align with the system's vocabulary. Additionally, parser 208 may categorize different parts of the prompt, such as distinguishing between the core analytical request and any supplementary details or constraints.

The output from parser 208 may be the parsed analytical prompt 204B which is fed into intent classifier 210. Intent classifier 210 may analyze the parsed analytical prompt 204B to determine the specific intent or purpose behind the request. This component may categorize the prompt into predefined intent categories, which may help guide subsequent processing steps within the AI processing system 118. The intent categories identified by the classifier may include, but are not limited to, data retrieval, trend analysis, predictive modeling, comparative analysis, or specific domain-related tasks. For example, if the prompt asks about “liquid underpriced bonds similar to a particular security,” the intent classifier may categorize this as a request for comparative analysis within the trading domain. This classification may help in selecting appropriate data sources 108 using domain hierarchy tree 122. In some implementations, intent classifier 210 may also assign confidence scores to its classifications, allowing the domain hierarchy tree 122 to handle ambiguous requests more effectively, such as by traversing multiple tree branches. Also, if the confidence score falls below a certain threshold, the AI processing system 118 may request clarification from the user via user interface 112 or apply multiple processing paths in domain hierarchy tree 122 to ensure a comprehensive response.

AI processing system 118 may apply the parsed analytical prompt 204B and the classifiers to domain hierarchy tree 122 to determine data sources 108 that may be used to generate an answer. As discussed above, domain hierarchy tree 122 stores domain or data source descriptions, expert knowledge, and few-shot examples corresponding to the domains and data sources in its nodes. FIG. 3 is a diagram 300 of a domain hierarchy tree 122 according to some embodiments. Domain hierarchy tree 122 includes multiple nodes 302, 304. The top and middle nodes, such as domain nodes 302A and 302B of domain hierarchy tree 122 may correspond to information associated with various domains. The leaf or bottom nodes, such as nodes 304A-D may correspond to information associated with various data sources 108. Each node 302 and intervening nodes (not shown) may include a domain description 306 and few-shot examples 308. For example, domain node 302A may include a domain description 306A and few-shot examples 308A and domain node 302B may include a domain description 306B and few-shot examples 308B. Domain descriptions 306A and 306B may contain detailed information about the respective domains, including key concepts, domain knowledge, and domain terminology. Few-shot examples 308A and 308B may provide sample queries and corresponding responses that are representative of the types of analytical requests typically handled within each domain. These descriptions and examples may help guide the traversal of the domain hierarchy tree 122 and improve the accuracy of query processing.

In some embodiments, leaf nodes 304A-D may contain specific information about datasets and APIs that may be accessed to retrieve and manipulate relevant data for processing prompt 204B. Leaf nodes 304A and 304B may include dataset descriptions 310A and 310B of datasets stored in data source 108A and data source 108B and associated few-shot examples 312A and 312B. These dataset descriptions 310A-B may provide details about the type of data contained within each dataset (e.g., model data, analytics data, auxiliary data), its structure, update frequency, etc. The few-shot examples 312A-B in nodes 304A-B may illustrate typical queries or data retrieval operations that can be performed on data sources 108A-B to access and manipulate the respective datasets. For instance, leaf node 304A may describe a dataset containing historical bond trading information. The description may specify that this dataset includes fields such as bond identifiers, trading dates, prices, volumes, and yield rates. The few-shot examples in node 304A may demonstrate how to query this dataset for specific bond performance metrics or how to retrieve trading data for a particular time period. Similarly, leaf node 304B may describe a dataset of company financial information. Its description may outline the types of financial data available, such as revenue figures, profit margins, debt ratios, and market capitalization. The few-shot examples in this node may show how to extract financial metrics for a given company or how to compare financial data across multiple companies.

Leaf nodes 304C and 304D may contain information about APIs that can be used to access to manipulate data. Leaf nodes 304C and 304D may include API descriptions 310C and 310D that may store authentication requirements, endpoint details, and example API call formats. Few-shot examples 312C and 312D in leaf nodes 304C and 304D may include example API calls, demonstrate how to construct API requests, and handle API call responses. For example, leaf node 304C may include an API description for accessing real-time market data from data source 108C, with few-shot examples 312C demonstrating how to retrieve current stock prices or calculate moving averages. The API call examples in leaf node 304C may show how to specify ticker symbols, time ranges, and data frequency when making requests. Similarly, leaf node 304D may contain an API description for accessing climate data in data source 108D, with few-shot examples 312D illustrating how to retrieve historical weather patterns or forecast future climate trends for specific geographical regions.

In yet another example, domain node 302A may be a trading domain, and domain node 302B may be a climate domain. Domain nodes 302A and 302B may be traversed to reach the leaf nodes 304A-D. For example, domain node 302A may be traversed to reach leaf nodes 304A-C that store information corresponding to dataset in data source 108A, dataset in data source 108B, and API accessing data source 108C. In some instances, dataset accessible from node 304A may be a trading dataset, dataset accessible from leaf node 304B may be a quote dataset, and API accessible from leaf node 304C may be an explainability API. Domain node 302B may be traversed to reach a leaf node 304D corresponding to the climate proxy API.

AI processing system 118 may traverse the nodes in domain hierarchy tree 122 using a combination of the analytical prompt 204B and the output from intent classifier 210. The system may start at the top-level domain nodes, such as 302A and 302B, and compare the content of the analytical prompt and the classified intent against the domain descriptions 306A and 306B, as well as the few-shot examples 308A and 308B associated with each node. Based on the closest matches, the AI processing system 118 may select the most relevant domain node and proceed to its child nodes, repeating this comparison process at each level of the domain hierarchy tree 122. For example, for an intent classifier indicting “bonds,” “trading” or “comparative analysis,” the traversal may proceed to domain node 302A, rather than domain node 302B.

As the traversal continues, AI processing system 118 may narrow down the search path, moving through intermediate nodes until it reaches the leaf nodes 304A-D. At each step, the system may refine its understanding of the query requirements by matching against increasingly specific descriptions and examples. Once the AI processing system 118 reaches the leaf nodes, it may identify one or more relevant datasets or APIs that can access data sources 108A-D provide the necessary data to answer the analytical prompt 204B. The leaf nodes 304A-D may contain detailed information about the datasets or APIs, including descriptions 310A-D and few-shot examples 312A-D, which the system may use to formulate precise queries or API calls to retrieve the required data from the corresponding data sources 108A-D as discussed below.

Going back to FIG. 2, AI processing system 118 may include a plan generator 212 and a data extractor 214. Plan generator 212 may create a comprehensive strategy for generating an answer based on the parsed analytical prompt 204B and the selected leaf nodes from domain hierarchy tree 122. The plan generator 212 may analyze the intent and specific requirements identified in the parsed prompt, along with the information available in the selected leaf nodes, such as one or more nodes 304A-D, to determine the sequence of operations needed to fulfill the analytical prompt 204B. This may involve identifying which data sources 108 with datasets or APIs to query, specifying the order of data retrieval and processing steps, and outlining data transformations or calculations, etc.

In some cases, the plan generator 212 may create a multi-step plan that includes parallel operations to optimize performance. The generated plan may include instructions for data extraction from various data sources 108, specifying which fields to retrieve from each dataset, what API calls to make, and/or what parameters to use in API calls. It may also outline any data joining or aggregation steps, as well as any specific analytical operations or models that need to be applied to the data. The plan may be structured in a way that allows for dynamic adjustments based on intermediate results, potentially incorporating conditional logic to handle various scenarios that may arise during the execution of the plan.

Data extractor 214 may be responsible for retrieving relevant data from the data sources 108 based on the plan created by the plan generator 212. In some instances, data extractor 214 may use an API call generator 216 and a query generator 218 to interface with various data sources 108 to extract the information.

Data extractor 214 may invoke an API call generator 216 to create API calls for accessing API 224 from data sources 108 as specified in the plan. API call generator 216 may utilize the information provided in the leaf nodes of domain hierarchy tree 122, including API descriptions and few-shot examples, to construct appropriate API calls. These calls may be tailored to the specific requirements of each API, incorporating authentication tokens, parameters, API call format, and endpoint details.

Once the API calls are generated, they may be passed through debugger 220 for validation and error checking. Debugger 220 may analyze the structure and syntax of the API calls, verifying that they conform to the expected format and include the required elements. This debugging process may help identify and rectify potential issues before execution, such as missing parameters or incorrect endpoint URLs.

After debugging, the validated API calls may be sent to API execution engine 222 for execution. API execution engine 222 may handle the actual communication with the target APIs 224, managing aspects such as connection establishment, request transmission, and response handling. It may also implement retry logic and error handling mechanisms to ensure robust interaction with the APIs. The target APIs 224 may be used to retrieve data from various applications, send data for mathematical manipulation and processing, receive results of the manipulation, and the like.

Upon receiving the response from the API 224, the API execution engine 222 may pass the response back through debugger 220 for further validation and error checking. Debugger 220 may analyze the structure and content of the API response, verifying that it conforms to the expected format and contains all required data elements. This additional debugging step may help identify any issues with the received data, such as missing fields, unexpected data types, or error messages returned by the API. In cases where the response does not meet the expected criteria, debugger 220 may flag the issue for further investigation or trigger a retry mechanism to attempt the API call again with modified parameters.

In parallel or in sequence with API-based data retrieval, data extractor 214 may invoke query generator 218 to create queries for accessing data 230 from one or more data sources 108 as outlined in the plan. Query generator 218 may leverage information from the leaf nodes of domain hierarchy tree 122, including dataset descriptions and few-shot examples, to construct appropriate queries. These queries may be optimized for the specific structure and schema of each target dataset in a corresponding data source.

Similar to the API calls, the generated queries may undergo a debugging process using debugger 226. This step may involve syntax checking, validation of table and column references, and verification of query logic. Debugger 226 may help identify potential issues such as incorrect join conditions, missing filters, or incompatible data type comparisons.

Following the debugging process, the validated queries may be passed to query execution engine 228 for execution. Query execution engine 228 may manage the connection to the relevant data sources, execute the queries, and handle the retrieval of data 230. It may also implement optimizations such as query parallelization or result caching to enhance performance, especially when dealing with large datasets or complex query operations. The queries may retrieve data 230, which may be mathematically manipulated based on the instructions in the query. After the query execution engine 228 retrieves data 230, data 230 may also undergo a debugging process using debugger 226. This additional debugging step may involve validating the structure and content of the retrieved data 230, checking for data integrity issues, and ensuring that the data meets the expected format and quality standards. Debugger 226 may perform checks such as verifying data types, identifying missing or null values, and flagging any anomalies or outliers in the dataset. In cases where data quality issues are detected, debugger 226 may trigger data cleansing routines or alert the system to potential problems that may affect the accuracy of subsequent analysis.

By utilizing both API-based and query-based data retrieval methods, data extractor 214 may efficiently gather the necessary information from various data sources 108 as specified in the plan. This dual approach may allow the AI processing system 118 to handle a wide range of data access and data manipulation scenarios, from real-time API-driven data feeds to complex analytical queries on structured datasets.

Data aggregator 231 may combine and process the data 230 retrieved from one or more data sources 108 and results obtained through code execution engine 236 and API calls via API 224. Data aggregator 231 may apply different aggregation techniques depending on the nature of the data and the requirements specified in the plan generated by plan generator 212. In some cases, data aggregator 231 may handle complex scenarios where data from multiple data sources 108 needs to be integrated coherently. It may resolve inconsistencies in data formats, handle missing values, and align timestamps or other key identifiers across different datasets.

Code generator 232 may receive the aggregated data from data aggregator 231 and utilize it to generate code for further processing. The generated code may be a prompt to machine learning framework 124 that includes aggregated data, analytical prompt 204, prompt enhancements, and the like. In some cases, the code may also apply machine learning algorithms, including but not limited to regression models, clustering techniques, or neural network model 120.

Once the code is generated, it may be passed to code execution engine 236 for execution. Code execution engine 236 may provide a runtime environment capable of interpreting and executing various programming languages, such as Python, R, or Java, that may be included in the code. In some implementations, the execution engine may support parallel processing or distributed computing to handle large-scale data operations efficiently.

Before execution, debugger 234 may be employed to perform comprehensive code validation. This may involve static code analysis to validate the code structure, checking for syntax errors, logical inconsistencies, or potential security vulnerabilities. Debugger 234 may also conduct dynamic analysis during runtime to identify potential errors, memory leaks, or performance bottlenecks. After execution, the debugger may analyze the output for unexpected results or error conditions.

In certain scenarios, the code execution may require accessing neural network model 120 within machine learning framework 124 to process the prompt included in the code. This interaction may be facilitated through endpoint 244, which may serve as a sophisticated communication interface between AI processing system 118 and machine learning framework 124. Endpoint 244 may implement various communication protocols, such as REST APIs, gRPC, or WebSocket, to enable seamless data exchange.

Neural network model 120, which may be a large language model (LLM), may execute the prompt included in the code that is received through endpoint 244 in a specialized runtime environment within machine learning framework 124. This environment may be optimized for processing natural language inputs and generating appropriate outputs based on the model's training. The LLM may interpret the code as a series of instructions or prompts, leveraging its vast knowledge base to understand the context and intent of the code. In some cases, the model may break down complex code structures into smaller, more manageable components, processing each part sequentially or in parallel depending on the task requirements.

The execution process within neural network model 120 may involve multiple stages, including tokenization of the input code, embedding of the tokens into high-dimensional vector spaces, and passing these embeddings through various layers of the neural network. Each layer may perform specific operations, such as attention mechanisms or feed-forward computations, to generate intermediate representations. The final output may be produced through a decoding process, where the model generates a response based on its understanding of the input code and the task at hand. This response could range from text outputs to more complex data structures or even executable code snippets, depending on the nature of the original request and the capabilities of the LLM. The neural network model 120 processing is further discussed in detail in FIG. 5.

To ensure efficient and secure data transfer between the systems, endpoint 244 may employ various data serialization formats like JSON, Protocol Buffers, or Apache Avro. It may also implement encryption protocols and authentication mechanisms to maintain data integrity and confidentiality during transmission.

Upon receiving results from machine learning framework 124, these outputs may undergo another round of debugging using debugger 234. This post-execution debugging process may involve verifying the integrity of the returned data structures, checking for any unexpected null values or data type mismatches. Debugger 234 may also assess the correctness of the machine learning model's output by comparing it against predefined benchmarks or expected ranges. In some implementations, this may include statistical tests to evaluate the model's performance metrics or cross-validation techniques to ensure the reliability of the results across different data subsets.

Once data aggregator 231 receives the output from code execution engine 236, it may pass the result to response generator 233. Response generator 233 may then generate a response to analytical prompt 204B using the processed data. For example, response generator 233 may analyze the aggregated data and results to formulate a coherent and informative response. In some cases, response generator 233 may utilize templates or pre-defined response structures, filling in the relevant information based on the specific query and results.

In some implementations, response generator 233 may incorporate data visualization techniques, generating charts, graphs, or other visual representations of the data to enhance the clarity and impact of the response. It may also include relevant metadata, such as confidence scores or data sources, to provide context and support for the generated insights.

Response generator 233 may also employ techniques to ensure the generated response is concise yet comprehensive, balancing the need for detailed information with readability and user-friendliness. This may involve summarizing complex analytical results, providing high-level overviews with options for users to access more detailed information if desired.

After the response is generated, it may be passed to the RPC framework 206. As discussed above, RPC framework 206 may handle the communication between the server-side components and the client-side application. It may package the response in an appropriate format for transmission, potentially applying compression or encryption techniques to optimize data transfer and ensure security. RPC framework 206 may then transmit the response to user interface 112 via AI plug-in 114. AI plug-in 114 may receive the response and process it for display within the user interface 112. This processing may involve formatting the response to fit the UI layout, applying any necessary styling, or breaking down the response into manageable sections for easier consumption by the user.

User interface 112 may display the processed response to the user, potentially with options for further interaction, such as drilling down into specific data points, requesting additional analysis, or saving the results for future reference. This completes the cycle from the initial analytical prompt to the delivery of a comprehensive, data-driven response to the user.

In some cases, response generator 233 may transmit the result from data aggregator 231 to validator 235 for additional verification before presenting the final response to the user. Validator 235 may access a repository of ground truths 238, which may be stored in a dedicated database or another form of memory storage. These ground truths may include known correct answers, validated data points, or expected outcomes for specific types of queries or analytical operations. The validator 235 may compare the generated result against these ground truths to ensure accuracy and reliability.

During the validation process, validator 235 may employ various techniques to assess the quality and correctness of the result. This may include statistical comparisons, pattern matching, or more complex validation algorithms depending on the nature of the data and the specific requirements of the analysis. If the validation process identifies discrepancies or inconsistencies between the generated result and the ground truths, the validator 235 may flag the result as potentially inaccurate or unreliable.

In the event that validation fails, validator 235 may initiate a feedback loop within the AI processing system 118. The validator may transmit the problematic result, along with relevant ground truth information, back to parser 208. This may trigger a reprocessing of the analytical prompt 204B, with parser 208 potentially adjusting its interpretation or classification of the input and/or intent classifier 210 adjusting its classifications of analytical prompt 204B. The AI processing system 118 may then generate a different result based on this refined understanding, potentially utilizing alternative data sources, analytical methods, or processing pathways. This iterative process may continue until a result that satisfies the validation criteria is produced, helping to ensure the accuracy and reliability of the final response provided to the user.

AI governance engine 240 may analyze prompts 204A-B, responses generated by machine learning framework 124, response generator 232, and intermediate responses produced by other components within the AI processing system 118 to ensure data transparency, minimize hallucinations, and maintain overall system integrity. This analysis may involve examining the content, structure, and metadata of prompts and responses at various stages of processing. The governance engine may employ natural language processing techniques, statistical analysis, and machine learning models to detect potential inconsistencies, biases, or inaccuracies in the data flow.

In some implementations, AI governance engine 240 may maintain a log of all prompts, intermediate processing steps, and final responses. This log may be used to trace the decision-making process and data transformations throughout the system. The AI governance engine 240 may compare the information in this log against predefined rules, ethical guidelines, and data quality metrics to identify any deviations or anomalies. Additionally, AI governance engine 240 may interface with validator 234 and ground truth database 238 to cross-reference generated responses against known reliable information, helping to detect and flag potential hallucinations or inaccuracies in the system's outputs. This comprehensive monitoring and analysis approach may enhance the overall transparency and reliability of the AI processing system 118.

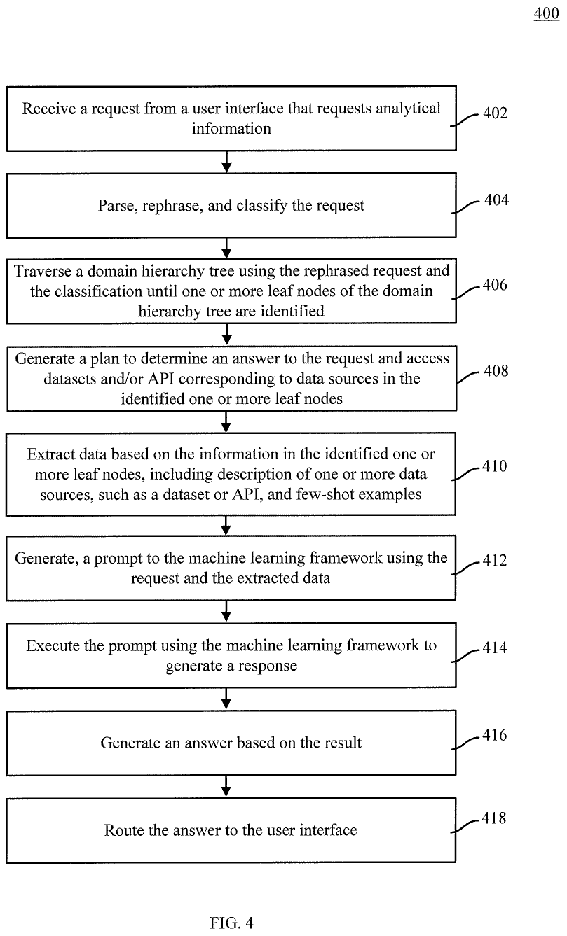

FIG. 4 is a flowchart of a method 400 for generating content using a domain hierarchy tree and an AI processing system, according to some embodiments. One or more of the operations 402-418 of method 400 may be implemented, at least in part, in the form of executable code stored on non-transitory, tangible, machine-readable media that, when run by one or more processors, may cause the one or more processors to perform one or more of the operations 402-418.

At operation 402, a request may be received from the user interface 112. The request may include a query that requests an analytical analysis that requires complex data analysis or mathematical computations. This type of request may be what AI plug-in 114 identified as analytical prompt 204B.

At operation 404, the received request may be parsed, rephrased, and classified. The parser 208 in the AI processing system 118 may analyze and decompose the request into its constituent elements, identifying key components such as the main query, specified parameters, and contextual information. The intent classifier 210 may also classify the request. The classification of the request may guide the traversal through the domain hierarchy tree 122, helping to efficiently navigate the domain hierarchy tree 122 to identify the relevant leaf nodes 304 for extracting or manipulating data from corresponding data sources 108 to generate an answer the request.

At operation 406, the domain hierarchy tree 122 is traversed. For example, the classification and the parsed request may traverse the domain hierarchy tree until one or more leaf nodes 304 of the domain hierarchy tree 122 are reached. This traversal may involve comparing the classification and/or words or content of the parsed request against the domain descriptions 306 and few-shot examples 308 associated with each node in the domain hierarchy tree 122 until leaf node(s) 304 are reached.

At operation 408, a plan to determine an answer to the request is generated. Plan generator 212 may create a comprehensive strategy for generating an answer to the request based on the parsed request and the reached leaf nodes 304 from domain hierarchy tree 122. This plan may outline the sequence of operations for fulfilling the query, including which data sources to access, the order of data retrieval and processing steps, and any necessary data transformations or calculations.

At operation 410, data is extracted based on the information in the one or more leaf nodes reached during the traversal of the domain hierarchy tree 122. This information may include descriptions 310 of one or more data sources 108 that store datasets or are accessible via APIs, and few-shot examples 312. The data extractor 214 may utilize this information to retrieve and manipulate relevant data 230 using query generator 218. For API-based data sources, API call generator 216 may construct appropriate API calls, which are then executed by API execution engine 222 to interface with API 224. The data extraction may proceed according to the action plan generated in operation 408, and may repeat multiple times. The data extraction process may also extract data 230 or access API 224 in sequence or in parallel.

At operation 412, a prompt or code to the neural network model 120 may be generated based on the extracted data and the parsed request. This prompt or code may incorporate data extracted in operation 410 along with the context and intent of the request as interpreted by the parser 208.

At operation 414, the generated prompt or code may be executed. For example, the prompt may be transmitted to machine learning framework 124 where it may be processed by neural network model 120 to generate a response to the prompt.

At operation 416, an answer to the request is generated. The response generator 233 may generate an answer to the request based on result from the executed prompt. For example, the response generator 233 may convert the result generated by neural network model 120 into a coherent and informative response tailored to the original request.

At operation 418, the answer may be routed to the user interface 112. The RPC framework 206 may handle the communication between the server-side components and the client-side application, transmitting the response to the user interface 112 via the AI plug-in 114 for display to the user.

FIG. 5 is a simplified diagram illustrating the neural network structure that may be implemented in one or more neural network models 120, according to some embodiments. FIG. 5 is a simplified diagram illustrating the neural network structure that may be implemented by one or more components in neural network model 120, according to some embodiments. Neural network model 120 may be a perceptron neural network, a feed forward neural network, a multilayer perceptron network, a convolutional neural network, a radial basis functional neural network, a recurrent neural network, an LSTM (Long Short-Term Memory) network and the like. In some instances, neural network model 120 may be implemented as a generative pre-trained transformer (GPT) model, large language model (LLM), or a Bidirectional Encoder Representations from Transformers (BERT) model.

Neural network model 120 may comprise neural network architecture. The example neural network architecture may comprise an input layer 502, one or more hidden layers 504 and an output layer 506. The neural network model 120 may be built as a collection of connected units or nodes, referred to as neurons 508. Each layer 502, 504, or 506 may comprise the same or different number of neurons or nodes 508, with neurons between layers being interconnected according to a specific topology. Each neuron 508 may be associated with an adjustable weight. The neurons 508 may be aggregated into layers 502, 504, 506 such that different layers may perform different transformations on the respective input to generate a transformed output, which is an input for the subsequent layer. Further, different layers in neural network model 120 may be combined into their own neural network models, such that an output layer of one neural network model is an input into the next neural network model, until a final output layer 506 is reached.

Input layer 502 receives input data, such as prompts comprising domain descriptions, few-shot examples, dataset or API, and a query for data. The number of nodes (neurons) in the input layer 502 may be determined by the dimensionality of the input data (e.g., the length of a vector of a given example of the input). Each node 508 in the input layer 502 may represent a feature or attribute of the input. In some embodiments, input layer 502 may be an embedding layer that may generate embeddings from input data. For example, words or tokens in the input data may be converted into vectors of fixed size called embedding vectors. The embedding vectors are mapped into a high-dimensional space. Additionally, positional encodings are added to the embedding vectors that may preserve the order of words in the input. Thus, each word and/or number in the input data may be transformed into embedding vectors, with the position each word and/or number maintained using the positional embeddings.

The hidden layers 504 are intermediate layers located between the input and output layers 502, 506 of the neural network model 120. Although three hidden layers 504 are shown, there may be any number of hidden layers in the neural network model 120. Hidden layers 504 may extract and transform the input data through series of weighted computations and activation functions associated with individual neurons.

For example, the neural network model 120 may receive prompts and data at input layer 502 and generate commentaries in an output of output layer 506. To perform the transformation, each neuron 508 receives input signals (which may be input to neural network model 120 or output of the preceding layer), performs a weighted sum of the inputs according to weights assigned to each connection and then applies an activation function associated with the respective neuron 508 to the result. The output of the neuron is passed to the next layer of neurons or serves as the final output of the network. The activation function may be the same or different across different layers 502, 504, 506, and may be different at neurons 508 within each layer. Example activation functions include but are not limited to Sigmoid, hyperbolic tangent, Rectified Linear Unit (ReLU), Leaky ReLU, Softmax, and/or the like. In this way, input data received at the input layer 502 is transformed by hidden layers 504 into different values indicative of data characteristics corresponding to a task that the neural network model 120 has been trained to perform.

In some embodiments, hidden layers 504 may further be combined in layers and blocks. For example, hidden layers 504 may be combined into one or more of a drop-out layer, transformer blocks, a normalization layer, and a linear layer. The outputs of one layer may be inputs into the subsequent layer. The transformer blocks may further include a portion of hidden layers that comprise an encoder and another portion of hidden layers that comprise a decoder. The encoder may also include a masking layer that masks a portion of the input into the layer. In some instances, the input into a transformer block may be fed into multiple layers, such as into both the encoder and the decoder.

In some embodiments, transformer blocks may be divided into a multi-head self-attention layer, a normalization layer, one or more feed forward neural networks, residual connections, and a drop-out layer. The multi-head self-attention layer may focus on different areas of input. The feed forward neural network may include two linear layers, with each layer including an activation function at their neurons. Normalization layer may normalize the output of the previous layer, e.g., the self-attention layer. The residual connection may be used to help gradient flow during training. The drop-out layer may prevent overfitting by randomly setting some neurons to zero during each training pass. The embedding vectors from input layer 502 may flow sequentially into transformer blocks discussed above. In some instances, embedding vectors may be fed into multiple layers within each transformer block.

The output layer 506 is the final layer of the neural network structure. It produces the network's output or prediction based on the computations performed in the preceding layers (e.g., 502, 504). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class. In the embodiments discussed herein, an output of output layer 506 may be a query that is executable by one or more data sources or APIs.

Neural network model 120 may also be implemented by hardware, software, and/or a combination thereof. For example, neural network model 120 may comprise a specific neural network structure implemented and run on various hardware platforms, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware may be used to implement the neural network structure is specifically configured based on factors such as the complexity of the neural network, the scale of the tasks (e.g., training time, input data scale, size of training dataset, etc.), and the desired performance.

Neural network model 120 may be trained by iteratively updating the underlying weights of the neurons 508, etc., bias parameters and/or coefficients in the activation functions associated with neurons 508. The weights may be updated based on a loss function, such as a mean squared estimation error (MSEE), cross-entropy loss, log-loss, and the like. For example, during training, the training data such as few-shot examples, APIs, queries, etc., are fed into neural network model 120 over thousands of iterations. The training data flows through the network's layers 502, 504, 506, with each layer performing computations based on its weights, biases, and activation functions until the output layer 506 produces the output.

The training data may be labeled with an expected output (e.g., a “ground-truth” and a corresponding ground truth label). The output generated by the output layer 506 is compared to the expected output from the training data to compute a loss function that measures the discrepancy between the predicted output and the expected output. In some embodiments, the negative gradient of the loss function may be computed with respect to the weights of each layer individually. This negative gradient is computed one layer at a time, iteratively backward from the last layer 506 to the input layer 502 of the neural network model 120. These gradients quantify the sensitivity of the network's output to changes in the parameters. The chain rule of calculus is applied to efficiently calculate these gradients by propagating the gradients backward (in a back propagation network) from the output layer 506 to the input layer 502.

Parameters of the neural network are updated backwardly from the last layer to the input layer (backpropagating) based on the computed negative gradient using an optimization algorithm to minimize the loss. The backpropagation from the last layer 506 to the input layer 502 may be conducted for a number of training samples in a number of iterative training epochs. In this way, parameters of the neural network model 120 may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. In a multiple neural network embodiment, the neural network models may be trained separately and then combined together and trained as a single neural network model 120.

Neural network parameters may be trained over multiple stages. For example, initial training (e.g., pre-training) may be performed on one set of training data, and then an additional training stage (e.g., fine-tuning) may be performed using a different set of training data, such as machine-readable code in one or more programming languages. In some embodiments, all, or a portion of parameters of one or more neural-network models being used together may be frozen, such that the “frozen” parameters are not updated during that training phase. This may allow, for example, a smaller subset of the parameters to be trained without the computing cost of updating all the parameters.

Therefore, the training process transforms the neural network into an “updated” trained neural network with updated parameters such as weights, activation functions, and biases. The trained neural network thus improves neural network technology for generating executable queries that may be executed by a database, another application interface, and the like to retrieve data.

Once training is complete, the trained neural network model 120 may enter an inference stage where neural network model 120 may be used to generate queries that may be executed to retrieve data from various data sources.

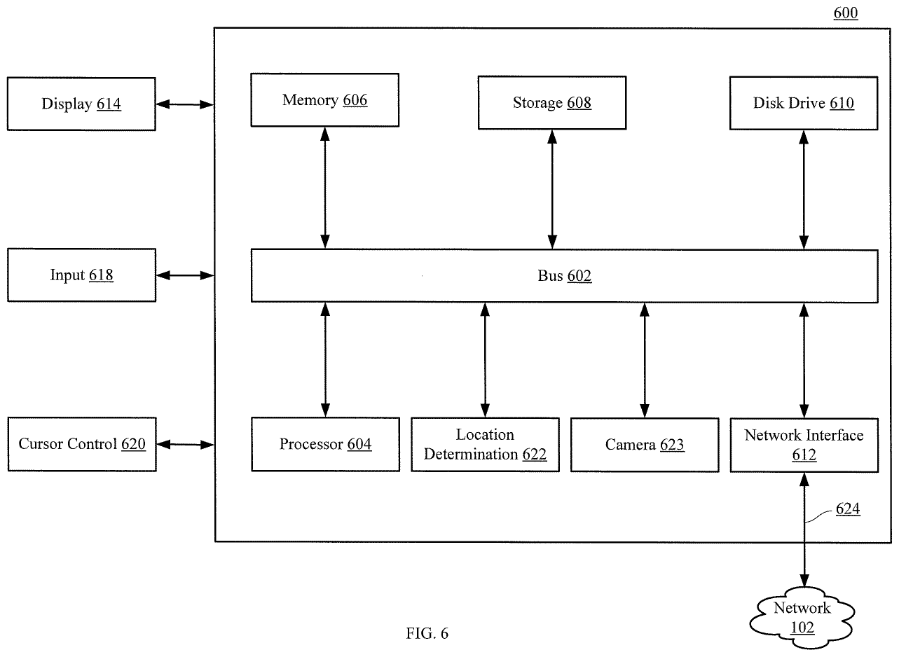

Referring now to FIG. 6, an embodiment of a computer system 600 suitable for implementing, the systems and methods described in FIGS. 1-5 is illustrated.

In accordance with various embodiments of the disclosure, computer system 600, such as a computer and/or a server, includes a bus 602 or other communication mechanism for communicating information, which interconnects subsystems and components, such as a processing component 604 (e.g., processor, micro-controller, digital signal processor (DSP), graphics processing unit (GPU), etc.), a system memory component 606 (e.g., RAM), a static storage component 608 (e.g., ROM), a disk drive component 610 (e.g., magnetic or optical), a network interface component 612 (e.g., modem or Ethernet card), a display component 614 (e.g., CRT or LCD), an input component 618 (e.g., keyboard, keypad, or virtual keyboard), a cursor control component 620 (e.g., mouse, pointer, or trackball), a location determination component 622 (e.g., a Global Positioning System (GPS) device as illustrated, a cell tower triangulation device, and/or a variety of other location determination devices known in the art), and/or a camera component 623. In one implementation, the disk drive component 610 may comprise a database having one or more disk drive components.

In accordance with embodiments of the disclosure, the computer system 600 performs specific operations by the processing component 604 executing one or more sequences of instructions contained in the system memory component 606, such as described herein with respect to the mobile communications devices, mobile devices, and/or servers. Such instructions may be read into the system memory component 606 from another computer readable medium, such as the static storage component 608 or the disk drive component 610. In other embodiments, hard-wired circuitry may be used in place of or in combination with software instructions to implement the disclosure.

Logic may be encoded in a computer-readable medium, which may refer to any medium that participates in providing instructions to the processing component 604 for execution. Such a medium may take many forms, including but not limited to, non-volatile media, volatile media, and transmission media. In one embodiment, the computer-readable medium is non-transitory. In various implementations, non-volatile media includes optical or magnetic disks, such as the disk drive component 610, volatile media includes dynamic memory, such as the system memory component 606, and transmission media includes coaxial cables, copper wire, and fiber optics, including wires that comprise the bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 600. In various other embodiments of the disclosure, a plurality of the computer systems 600 coupled by a communication link 624 to the network (e.g., such as a LAN, WLAN, PSTN, and/or various other wired or wireless networks, including telecommunications, mobile, and cellular phone networks) may perform instruction sequences to practice the disclosure in coordination with one another.

The computer system 600 may transmit and receive messages, data, information, and instructions, including one or more programs (i.e., application code) through the communication link 624 and the network interface component 612. The network interface component 612 may include an antenna, either separate or integrated, to enable transmission and reception via the communication link 624. Received program code may be executed by processor 604 as received and/or stored in disk drive component 610 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

1. A system comprising:
a memory; and
a processor coupled to the memory and configured to execute instructions that cause the processor to perform operations comprising:
receiving a request for analytical information;
traversing a domain hierarchy tree based on the request to identify one or more nodes corresponding to one or more data sources;
generating a plan to execute the request based on information in the identified one or more leaf nodes;
extracting data from the one or more data sources based on the generated plan;
generating a prompt for a neural network model based on the extracted data and the request;
executing the prompt using the neural network model to generate a result; and
generating an answer to the request based on the result from the neural network model.

2. The system of claim 1, wherein the domain hierarchy tree comprises multiple levels of the nodes, including top-level domain nodes and leaf nodes, and wherein the domain nodes store domain descriptions and domain few-shot examples and leaf nodes store data source descriptions and data source few-shot examples.

3. The system of claim 2, wherein traversing the domain hierarchy tree further comprises:
comparing information in the request to one or more domain descriptions and one or more data source descriptions.

4. The system of claim 2, wherein the data source descriptions in the leaf nodes contain information about datasets or APIs that can be accessed to retrieve data or generate API calls for processing the result.

5. The system of claim 2, wherein extracting the data from the one or more data sources further comprises:
generating at least one API call based on a data source description or a few-shot example in one of the one or more identified leaf nodes; and
executing the at least one generated API call with an API associated with the one of the one or more data sources to retrieve the data from the one or more data sources.

6. The system of claim 2, wherein extracting the data from the one or more data sources comprises:
generating at least one database query based on a data source description or a few-shot example in the one of the one or more identified leaf nodes; and
executing the at least one generated query to retrieve the data from the one of the one or more data sources.

7. The system of claim 1, wherein the operations further comprise:
aggregating the extracted data from the one or more data sources; and
generating code corresponding to the prompt for the neural network model that includes the aggregated extracted data.

8. The system of claim 1, wherein the neural network model is a large language model.

9. The system of claim 1, wherein the request for the analytical information uses mathematical computations or complex data analysis that is not performed by the neural network model.

10. A method comprising:
receiving a prompt comprising analytical information;
determining a classification for the prompt;
traversing a domain hierarchy tree stored in a memory based on the classification to identify one or more leaf nodes corresponding to one or more data sources, wherein the domain hierarchy tree comprises nodes storing one or more of domain descriptions, data-source descriptions, and few-shot examples;
generating a plan to execute the prompt based on one or more data source descriptions and one or more few-shot examples in the identified one or more leaf nodes;
extracting data from the one or more data sources based on the generated plan;
generating a second prompt for a neural network model based on the extracted data and the prompt comprising the analytical information;
executing the second prompt using the neural network model to generate a result; and
generating an answer to the prompt for the analytical information based on the extracted data and the result from the neural network model.

11. The method of claim 10, wherein the nodes in the domain hierarchy tree are at multiple levels, including top-level domain nodes, intermediate nodes, and leaf nodes associated with data sources.

12. The method of claim 11, wherein the leaf nodes contain the data source descriptions about datasets accessible to retrieve and manipulate relevant data for processing the prompt for the analytical information.

13. The method of claim 11, wherein the leaf nodes contain the data source descriptions about APIs that are accessible to retrieve and manipulate relevant data for processing the prompt for the analytical information.

14. The method of claim 10, wherein extracting the data from the one or more data sources comprises:
generating an API call based on information in one of the one or more identified leaf nodes; and
executing the generated API call at an API to retrieve the data from the one or more data sources.

15. The method of claim 10, wherein extracting the data from one or more data sources comprises:
generating a database query based on information in one of the one or more identified leaf nodes; and
executing the generated query to retrieve the data from the one or more data sources.

16. The method of claim 10, further comprising:
aggregating the extracted data from the identified one or more data sources; and
incorporating the aggregated extracted data into the second prompt.

17. The method of claim 10, further comprising:
validating the generated answer against a repository of ground truths; and
if the validation fails, reprocessing the prompt for the analytical information using an alternative data source accessible via the domain hierarchy tree.

18. The method of claim 10, further comprising:
generating a visualization graph based on the answer; and
transmitting the visualization graph to a user interface for display.

19. A non-transitory computer readable medium having instructions stored thereon, that when executed by a processor cause the processor to perform operations, the operations comprising:
receiving a request for information;
determining a classification for the request;
traversing a domain hierarchy tree based on the classification to identify a leaf node corresponding to a data source;
generating a plan to execute the request based on information in the identified leaf node;
extracting data from one or more data sources based on the generated plan;
generating a prompt for a neural network model based on the extracted data and the request;
executing the prompt using the neural network model to generate a result; and
generating an answer to the request based on the result from the neural network model.

20. The non-transitory computer readable medium of claim 19, wherein the domain hierarchy tree comprises multiple levels of nodes, including top-level domain nodes and leaf nodes, and wherein the domain nodes store domain descriptions and domain few-shot examples and leaf nodes store data source descriptions and data source few-shot examples.
